(19) United States
(12) Patent Application Publication
(10) Pub. No.: US 2026/0120330 A1
(43) Pub. Date: Apr. 30, 2026

(54) METHOD AND APPARATUS FOR ENCODING/DECODING POINT CLOUD BASED ON HYPERPRIOR MODEL

(71) Applicant: Electronics and Telecommunications Research Institute, Daejeon (KR)

(72) Inventors: Jun Sik KIM, Daejeon (KR); Gun BANG, Daejeon (KR); Soo Woong KIM, Daejeon (KR); Ji Hoon DO, Daejeon (KR); Seong Jun BAE, Daejeon (KR); Ha Hyun LEE, Daejeon (KR); Jung Won KANG, Daejeon (KR); Jin Soo CHOI, Daejeon (KR)

(73) Assignee: Electronics and Telecommunications Research Institute, Daejeon (KR)

(21) Appl. No.: 19/370,941

(22) Filed: Oct. 28, 2025

(30) Foreign Application Priority Data
Oct. 28, 2024 (KR) 10-2024-0148879
Sep. 11, 2025 (KR) 10-2025-0130190

(51) Int. Cl. G06T 9/00; G06T 3/40

(52) U.S. Cl. CPC G06T 9/001; G06T 3/40

(57) ABSTRACT

A method for decoding a point cloud according to a present disclosure, the method comprises: performing down-sampling on decoded initial coordinate information to obtain first coordinate information; generating a first tensor based on the first coordinate information and decoded first feature information; performing up-sampling on the generated first tensor; extracting second feature information based on a sorting order of second coordinate information included in the up-sampled first tensor; deriving hyperprior feature information from the second feature information based on a hyperprior entropy model; generating a second tensor based on the hyperprior feature information; and reconstructing the point cloud based on the second tensor.

### CROSS-REFERENCE TO RELATED APPLICATIONS

This application claims the benefit of earlier filing date and right of priority to Korean Application No. 10-2024-0148879, filed on Oct. 28, 2024, Korean Application No. 10-2025-0130190, filed on Sep. 11, 2025, the contents of which are all hereby incorporated by reference herein in their entirety.

### TECHNICAL FIELD

The present disclosure relates to an artificial intelligence-based point cloud encoding/decoding method. More specifically, the present disclosure relates to a hyperprior model-based point cloud encoding/decoding method and an apparatus configured to perform the same.

### BACKGROUND

AI-based point cloud compression is a technology that performs point cloud encoding and decoding using a neural network model. Based on the structure of the Variational Autoencoder (VAE), widely used in the field of AI-based image (video) compression, techniques necessary for 3D data processing, such as occupancy probability calculation and pruning, may be utilized.

When encoding/decoding an AI-based point cloud, the latent feature output from the encoder is assumed to have a Gaussian distribution and may be compressed using an arithmetic coding model. In this case, a factorized prior model may be used as the arithmetic encoding model. The factorized prior model has a problem with failing to achieve optimal compression performance when statistical dependencies exist within latent features. To address this issue, the hyperprior model is introduced, promising higher compression performance. However, in the hyperprior model, the resolution of the output latent features may be different, making it difficult to apply to point cloud data.

### SUMMARY

The technical object of the present disclosure is to provide a point cloud encoding/decoding method based on a hyperprior model that performs coordinate preserving down-sampling.

It is a further object of the present disclosure to provide a point cloud encoding/decoding method based on a hyperprior model that performs coordinate preserving up-sampling.

It is a further object of the present disclosure to provide a coordinate alignment-based feature extraction method.

The features briefly summarized above regarding the present disclosure are merely exemplary aspects of the detailed description of the present disclosure that follows and do not limit the scope of the present disclosure.

In accordance with an aspect of the present disclosure, the above and other objects can be accomplished by the provision of a method for decoding a point cloud, the method comprising: performing down-sampling on decoded initial coordinate information to obtain first coordinate information; generating a first tensor based on the first coordinate information and decoded first feature information; performing up-sampling on the generated first tensor; extracting second feature information based on a sorting order of second coordinate information included in the up-sampled first tensor; deriving hyperprior feature information from the second feature information based on a hyperprior entropy model; generating a second tensor based on the hyperprior feature information; and reconstructing the point cloud based on the second tensor.

In the method for decoding the point cloud according to the present disclosure, based on performing the down-sampling, connection relationship information between the decoded initial coordinate information and the first coordinate information is generated.

In the method for decoding the point cloud according to the present disclosure, the connection relationship information is determined by a method of representing a connection relationship of a predetermined pixel or voxel, and the method includes at least one of a coordinate vector, an index map, and an adjacency list method for tracking a correspondence relationship.

In the method for decoding the point cloud according to the present disclosure, the connection relationship information is generated based on a specified down-sampling method.

In the method for decoding the point cloud according to the present disclosure, the up-sampling for the first tensor is performed based on the connection relationship information.

In the method for decoding the point cloud according to the present disclosure, the first tensor is generated by connecting the first coordinate information and the decoded first feature information, and the connecting is performed based on a sorting order of the first coordinate information.

In the method for decoding the point cloud according to the present disclosure, the second tensor is generated by connecting the decoded initial coordinate information and the hyperprior feature information, and the connecting is performed based on a sorting order of the decoded initial coordinate information.

In the method for decoding the point cloud according to the present disclosure, the sorting order of the second coordinate information is determined by a predetermined coordinate information sorting method, wherein the method includes at least one of a space filling algorithm and an orthogonal coordinate system-based sorting method, and the space filling algorithm includes at least one of a Morton code and a Hilbert curve.

In the method for decoding the point cloud according to the present disclosure, information indicating whether down-sampling is performed on the decoded initial coordinate information is signaled.

In the method for decoding the point cloud according to the present disclosure, information indicating whether to derive the hyperprior feature is signaled.

In accordance with an aspect of the present disclosure, the above and other objects can be accomplished by the provision of an apparatus for decoding a point cloud, the apparatus comprising: one or more transceivers; one or more memories; and one or more processors, wherein the one or more processors being configured to: perform down-sampling on decoded initial coordinate information to obtain first coordinate information, generate a first tensor based on the first coordinate information and decoded first feature information, perform up-sampling on the generated first tensor, extract second feature information based on a sorting order of second coordinate information included in the up-sampled first tensor, derive hyperprior feature information from the second feature information based on a hyperprior entropy model, generate a second tensor based on the hyperprior feature information, and reconstruct the point cloud based on the second tensor.

In accordance with an aspect of the present disclosure, the above and other objects can be accomplished by the provision of a method for encoding a point cloud, the method comprising: encoding an initial tensor of the point cloud; performing down-sampling on the encoded initial tensor; extracting first feature information based on a sorting order of first coordinate information included in the down-sampled initial tensor; generating a first tensor based on the first coordinate information and the first feature information; performing up-sampling on the generated first tensor; extracting second feature information based on a sorting order of second coordinate information included in the up-sampled first tensor; and performing arithmetic encoding on a hyperprior feature information derived from the second feature information.

In the method for encoding the point cloud according to the present disclosure, based on performing the down-sampling, connection relationship information between initial coordinate information included in the initial tensor and the first coordinate information is generated.

In the method for encoding the point cloud according to the present disclosure, the connection relationship information is determined by a method of representing a connection relationship of a predetermined pixel or voxel, and the method includes at least one of a coordinate vector, an index map, and an adjacency list method for tracking a correspondence relationship.

In the method for encoding the point cloud according to the present disclosure, the connection relationship information is generated based on a specified down-sampling method.

In the method for encoding the point cloud according to the present disclosure, the up-sampling for the first tensor is performed based on the connection relationship information.

In the method for encoding the point cloud according to the present disclosure, the first tensor is generated by connecting the first coordinate information and the first feature information, and the connecting is performed based on the sorting order of the first coordinate information.

In the method for encoding the point cloud according to the present disclosure, the sorting order of the second coordinate information is determined by a predetermined coordinate information sorting method, wherein the method includes at least one of a space filling algorithm and an orthogonal coordinate system-based sorting method, and the space filling algorithm includes at least one of a Morton code and a Hilbert curve.

In the method for encoding the point cloud according to the present disclosure, information indicating whether to derive the hyperprior feature is signaled.

In accordance with an aspect of the present disclosure, the above and other objects can be accomplished by the provision of an apparatus for encoding a point cloud, the apparatus comprising: one or more transceivers; one or more memories; and one or more processors, wherein the one or more processors being configured to: encode an initial tensor of the point cloud, perform down-sampling on the encoded initial tensor, extract first feature information based on a sorting order of first coordinate information included in the down-sampled initial tensor, generate a first tensor based on the first coordinate information and the first feature information, perform up-sampling on the generated first tensor, extract second feature information based on a sorting order of second coordinate information included in the up-sampled first tensor, and perform arithmetic encoding on a hyperprior feature information derived from the second feature information.

The technical problems to be achieved in the present disclosure are not limited to the technical problems mentioned above, and other technical problems not mentioned herein may be clearly understood by those skilled in the art from the description below.

### BRIEF DESCRIPTION OF THE DRAWINGS

FIG. 1 is a flowchart illustrating the structure of a hyperprior entropy model according to one embodiment of the present disclosure.

FIG. 2 is a diagram illustrating a point cloud encoding apparatus based on a hyperprior model according to one embodiment of the present disclosure.

FIG. 3 is a diagram illustrating a point cloud decoding apparatus based on a hyperprior model according to one embodiment of the present disclosure.

FIG. 4 is a flowchart of a point cloud encoding method based on a hyperprior model according to one embodiment of the present disclosure.

FIG. 5 is a flowchart of a point cloud decoding method based on a hyperprior model according to one embodiment of the present disclosure.

FIG. 6 is a block diagram illustrating an apparatus according to one embodiment of the present disclosure.

### DETAILED DESCRIPTION

Since the present disclosure may be variously changed and have several embodiments, specific embodiments are illustrated in drawings and are described in detail in a detailed description. However, this is not to limit the present disclosure to a specific embodiment, and should be understood as including all changes, equivalents and substitutes included in an idea and a technical scope of the present disclosure. A similar reference numeral in a drawing refers to a like or similar function across multiple aspects. A shape and a size, etc. of elements in a drawing may be exaggerated for a clearer description. A detailed description on exemplary embodiments described below refers to an accompanying drawing which shows a specific embodiment as an example. These embodiments are described in detail so that those skilled in the pertinent art can implement an embodiment. It should be understood that a variety of embodiments are different each other, but do not need to be mutually exclusive. As an example, a specific shape, structure and characteristic described herein may be implemented in other embodiments without departing from a scope and a spirit of the present disclosure in connection with an embodiment. In addition, it should be understood that a position or arrangement of an individual element in each disclosed embodiment may be changed without departing from a scope and a spirit of an embodiment. Accordingly, a detailed description described below is not taken as a limited meaning and a scope of exemplary embodiments, if properly described, are limited only by an accompanying claim along with any scope equivalent to that claimed by those claims.

In the present disclosure, terms such as first, second, etc. may be used to describe a variety of elements, but the elements should not be limited by the terms. The terms are used only to distinguish one element from another element. As an example, without departing from a scope of a right of the present disclosure, a first element may be referred to as a second element and likewise, a second element may be also referred to as a first element. A term of and/or includes a combination of a plurality of relevant described items or any item of a plurality of relevant described items.

When an element in the present disclosure is referred to as being “connected” or “linked” to another element, it should be understood that the element may be directly connected or linked to that another element, but there may be another element therebetween. Meanwhile, when an element is referred to as being “directly connected” or “directly linked” to another element, it should be understood that there is no other element therebetween.

As construction units shown in an embodiment of the present disclosure are independently shown to represent different characteristic functions, it does not mean that each construction unit is composed in a construction unit of separate hardware or one piece of software. In other words, as each construction unit is included by being enumerated as each construction unit for convenience of a description, at least two construction units of each construction unit may be combined to form one construction unit or one construction unit may be subdivided into a plurality of construction units to perform a function, and an integrated embodiment and a separate embodiment of each construction unit are also included in a scope of a right of the present disclosure unless they are beyond the essence of the present disclosure.

A term used in the present disclosure is merely used to describe a specific embodiment, and is not intended to limit the present disclosure. A singular expression, unless the context clearly indicates otherwise, includes a plural expression. In the present disclosure, it should be understood that a term such as “include” or “have”, etc. is merely intended to designate the presence of a feature, a number, a step, an operation, an element, a part or a combination thereof described in the present specification, and does not preclude a possibility of presence or addition of one or more other features, numbers, steps, operations, elements, parts or their combinations. In other words, a description of “including” a specific configuration in the present disclosure does not exclude a configuration other than a corresponding configuration, and it means that an additional configuration may be included in a scope of a technical idea of the present disclosure or an embodiment of the present disclosure.

Some elements of the present disclosure are not necessary elements which perform an essential function in the present disclosure and may be optional elements for merely improving performance. The present disclosure may be implemented by including only a construction unit which is necessary to implement essence of the present disclosure except for an element merely used for performance improvement, and a structure including only a necessary element except for an optional element merely used for performance improvement is also included in a scope of a right of the present disclosure.

Hereinafter, an embodiment of the present disclosure is described in detail by referring to the drawings. In describing an embodiment of the present specification, when it is determined that a detailed description on a relevant disclosed configuration or function may obscure a gist of the present specification, such a detailed description is omitted, and the same reference numeral is used for the same element in the drawings and an overlapping description on the same element is omitted.

First, the terms used in this application are briefly explained as follows.

A point cloud may refer to a set of points in three-dimensional space. The point cloud may be represented by geometric and/or attribute information. The geometric information may be understood as being replaced by coordinate information. The attribute information may be understood as being replaced by feature information.

The coordinate information of the point cloud may represent position information in three-dimensional space.

The coordinate information of the point cloud may be defined based on a specific coordinate system (e.g., rectangular coordinate system, spherical coordinate system, etc.).

The feature information may represent information that quantifies the characteristics of a point. It may include at least one of color, transparency, reflectance, normal vector, and spherical harmonics function.

The latent feature may refer to feature values extracted or learned within a model by inputting data into a neural network.

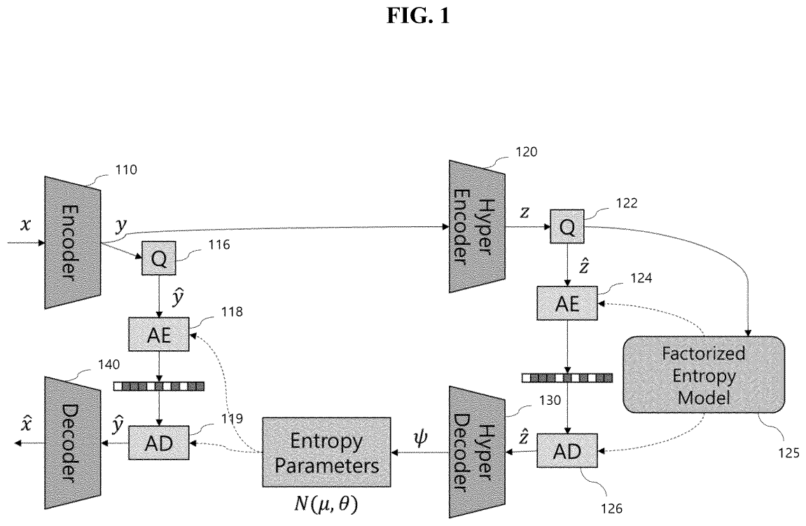

FIG. 1 is a flowchart illustrating the structure of a hyperprior entropy model according to one embodiment of the present disclosure.

Referring to FIG. 1, the hyperprior entropy model (also referred to as a hyperprior model) may transform input data x into y and z having Gaussian distributions.

y may be quantized through a quantization unit 116 and arithmetic encoded through an arithmetic encoding unit 118.

z may determine the mean (μ) and scale (θ) of y. \hat{z} may be derived as quantization (Q) is performed on z in the quantization unit 122. Arithmetic Encoding (AE) may be performed on \hat{z} in the arithmetic encoding unit 124.

The resolution of the input data x may be reduced as it passes through the encoder 110 and the hyper encoder 120 sequentially. Accordingly, y and z may have different resolutions.

In the arithmetic decoding unit 126, Arithmetic Decoding (AD) may be performed on the bitstream of \hat{z}. The arithmetic coding of \hat{z} may be performed based on the factorized entropy model 125.

The arithmetic decoded \hat{z} may be derived as Ψ by passing through the hyper decoder 130. Here, Ψ may have the same resolution as ŷ. As Ψ is input to the hyperprior entropy model, the latent feature may be learned to have μ and θ.

The arithmetic encoded ŷ may be arithmetic decoded based on μ and θ in the arithmetic decoding unit 119. Finally, ŷ may be output as a reconstructed \hat{x} having the original resolution through the decoder 140.

The hyperprior entropy model achieves high a compression ratio for ŷ by considering μ and θ in the probability distribution of ŷ. Since \hat{z}, which determines μ and θ, has a lower resolution than ŷ, the bitstream size of \hat{z} may also exhibit a high compression ratio.

However, in the case of point cloud compression, unlike 2D images, there is empty space within the resolution space (bounding box), so additional information about occupied and unoccupied spaces may be required. Accordingly, the compression ratio of the hyperprior entropy model may be reduced because occupancy information is required for each of ŷ and \hat{z} with different resolutions.

Accordingly, in this disclosure, it is intended to propose a method for encoding/decoding point cloud based on a hyperprior model, which performs coordinate-preserving down-sampling. According to the method of the present disclosure, a point cloud may be encoded/decoded without generating additional coordinate information by generating occupancy information of \hat{z} having a lower resolution than ŷ, using occupancy information of ŷ.

Meanwhile, it may be understood that the method of the present disclosure may input various 3D image data, including point cloud images.

For example, a mesh image with 3D coordinate information may be input. Alternatively, data that may be converted into a point cloud or mesh may be input.

The above-described 3D image data input is merely an example and is not limited thereto.

For convenience of explanation, the following description assumes the input data is a point cloud.

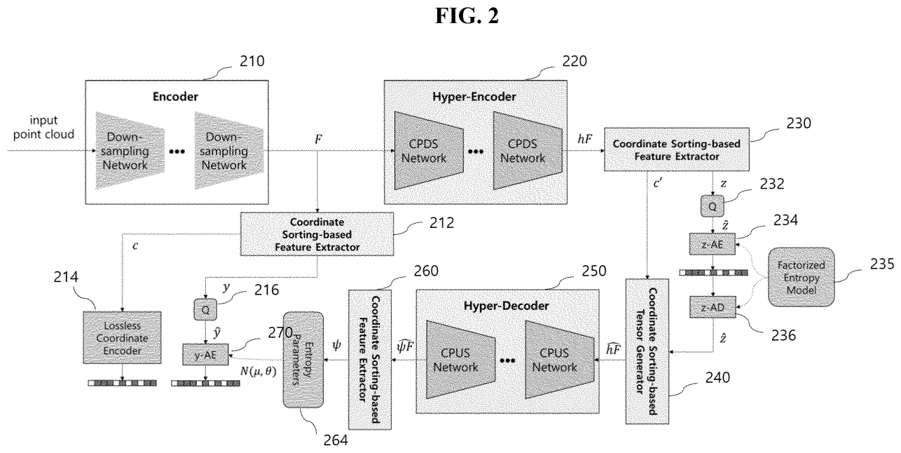

FIG. 2 is a diagram illustrating a point cloud encoding apparatus based on a hyperprior model according to one embodiment of the present disclosure.

The hyperprior entropy model-based point cloud encoder proposed in this disclosure may reconstruct the coordinates (c′) of [symbol] using only the coordinate information (c) of F by performing Coordinate Preserving Down Sampling (CDPS) and Coordinate Preserving Up Sampling (CDUS). There is no need to transmit additional information about c′ to the decoder. This will be described in detail below.

Referring to FIG. 2, the encoder 210 may perform down-sampling on the point cloud to encode an initial tensor including coordinate information and feature information.

A tensor (F) may be encoded by performing down-sampling on the input point cloud. The tensor may include coordinate information and feature information.

To generate a tensor, a down-sampling network-based encoding technique, which is commonly used in the field of autoencoder-based point cloud compression, may be used.

In addition to the above technique, a technique may be used to reduce the resolution of input data to a low resolution and generate latent features using a network including one or more MLPs.

Meanwhile, the encoded tensor (F) may be separated into coordinate information (c) and feature information (y) through a feature extraction unit 212. The coordinate information may be encoded through a lossless encoder 214. As the feature information passes through a quantization unit 216, the quantized feature information ŷ may be encoded.

Referring to FIG. 2, the hyper encoder 220 may perform down-sampling on the encoded initial tensor.

As a result of performing down-sampling on a tensor (F), a down-sampled tensor (hF) may be obtained.

According to one embodiment of the present disclosure, when performing down-sampling on a tensor, a connection relationship between down-sampled coordinate information and coordinate information before down-sampling may be stored. Coordinate information before down-sampling may be reconstructed as it is during up-sampling through the connection relationship.

According to one embodiment of the present disclosure, the connection relationship between the down-sampled coordinate information and the coordinate information before down-sampling may be generated in the form of a coordinate vector, an index map, or an adjacency list, etc., to track the correspondence relationship of pixels or voxels.

Alternatively, the connection between the down-sampled coordinate information and the coordinate information before down-sampling may be generated by specifying a down-sampling method. For example, if a method of selecting and sampling only voxel existing at a specific position is specified, the connection relationship may be generated by considering the specific position. A voxel may refer to a unit that divides a point cloud into a cube or a predetermined volume element. As an example, the voxel existing at the specific position may be a voxel at the upper right of the point cloud.

However, the above-described method is merely an example, and a variety of different methods for creating connection relationships between coordinates may be used.

According to one embodiment of the present disclosure, information indicating whether down-sampling is performed may be signaled. As an example, the information may be defined and signaled as an SEI message. The information may be signaled at one or more of a sequence level, a picture level, a slice level, or a tile level.

Referring to FIG. 2, the feature extraction unit 230 may extract the first feature information based on the sorting order of the first coordinate information included in the down-sampled initial tensor.

According to one embodiment of the present disclosure, in a tensor including coordinate information and feature information, coordinate information (c′) and feature information (z) may be separated based on the sorting order of coordinate information.

According to one embodiment of the present disclosure, a predetermined coordinate sorting method may be used to perform coordinate information sorting.

As an example, a space filling algorithm may be used. The space filling algorithm may include at least one of a Morton code and a Hilbert curve.

As an example, a sorting technique based on a coordinate axis (e.g., an orthogonal coordinate system axis such as the x-axis, y-axis, and z-axis) may be used.

However, the above-described method is merely an example, and a variety of different coordinate sorting methods may be used.

According to one embodiment of the present disclosure, information on a coordinate information sorting method used may be signaled. As an example, the information may be defined and signaled as an SEI message. The information may be signaled at one or more of a sequence level, a picture level, a slice level, or a tile level.

Referring to FIG. 2, arithmetic coding may be performed in the arithmetic encoding unit 234 and the arithmetic decoding unit 236 on the extracted feature information. Before performing arithmetic encoding, quantization may be performed in the quantization unit 232.

The tensor output through down-sampling may be used as hyperprior data through up-sampling. Here, the hyperprior data may refer to data input to a hyperprior entropy model. In this case, the feature information to be changed into hyperprior feature information may be compressed through arithmetic coding. As an example, a factorized entropy model 235 may be used. Here, the hyperprior feature information may refer to feature information that is input to and learned by the hyperprior entropy model.

According to one embodiment of the present disclosure, information indicating that the extracted feature information is used as hyperprior data may be signaled. That is, information indicating whether the extracted feature information is to be derived as hyperprior feature information may be signaled. For example, the information may be defined and signaled as an SEI message. The information may be signaled at one or more of a sequence level, a picture level, a slice level, or a tile level.

Referring to FIG. 2, the tensor generation unit 240 may generate a first tensor based on the first coordinate information and the first feature information.

According to one embodiment of the present disclosure, a tensor may be generated by receiving arithmetic-coded feature information as input. A tensor (\hat{F}) may be generated by connecting feature information (\hat{z}) to coordinate information (c′) based on the sorting order of coordinate information determined by the feature extraction unit 230.

Referring to FIG. 2, the hyper decoder 250 may perform up-sampling on the generated first tensor.

According to one embodiment of the present disclosure, up-sampling may be performed by receiving a tensor generated by a tensor generation unit 240 as input. As a result of performing up-sampling, a tensor ( [symbol] ) may be obtained. By performing up-sampling using the connection between the down-sampled coordinate information and the coordinate information before down-sampling, the coordinate information before down-sampling may be reconstructed without loss.

According to one embodiment of the present disclosure, the connection relationship between the down-sampled coordinate information and the coordinate information before down-sampling may be generated in the form of a coordinate vector, an index map, or an adjacency list, etc., to track the correspondence relationship of pixels or voxels.

Alternatively, the connection between the down-sampled coordinate information and the coordinate information before down-sampling may be generated by specifying a down-sampling method. For example, if a method of selecting and sampling only voxel existing at a specific position is specified, the connection relationship may be generated by considering the specific position. For example, the voxel existing at the specific position may be a voxel at the upper right of the point cloud.

However, the above-described method is merely an example, and a variety of different methods for creating connection relationships between coordinates may be used.

Meanwhile, according to one embodiment of the present disclosure, information indicating whether down-sampling is performed when up-sampling is performed may be obtained through a bitstream. For example, the information may be defined and signaled as an SEI message. The information may be signaled at one or more of a sequence level, a picture level, a slice level, or a tile level.

Referring to FIG. 2, the feature extraction unit 260 may extract second feature information based on the sorting order of second coordinate information included in the up-sampled first tensor.

According to one embodiment of the present disclosure, feature information (Ψ) may be extracted from a tensor ( [symbol] ) obtained as a result of performing up-sampling.

According to one embodiment of the present disclosure, a predetermined coordinate sorting method may be used to perform coordinate information sorting.

As an example, a space filling algorithm may be used. The space filling algorithm may include at least one of a Morton code and a Hilbert curve.

As an example, a sorting technique based on a coordinate axis (e.g., an orthogonal coordinate system axis such as the x-axis, y-axis, and z-axis) may be used.

However, the above-described method is merely an example, and a variety of different coordinate sorting methods may be used.

According to one embodiment of the present disclosure, information on a coordinate information sorting method used may be signaled. As an example, the information may be defined and signaled as an SEI message. The information may be signaled at one or more of a sequence level, a picture level, a slice level, or a tile level.

Referring to FIG. 2, the hyperprior feature information may be derived from the second feature information based on the hyperprior entropy model 264.

According to one embodiment of the present disclosure, learning based on a hyperprior model may be performed on extracted feature information. By learning feature information using a hyperprior entropy model 264, the feature information may be changed into hyperprior feature information having a mean (μ) and a scale (θ).

Referring to FIG. 2, the arithmetic encoding unit 270 may perform arithmetic encoding on the hyperprior feature information.

Arithmetic encoding may be performed in the arithmetic encoding unit 270 on the hyperprior feature information obtained using the hyperprior entropy model.

According to one embodiment of the present disclosure, information indicating whether to use (derive) hyperprior feature information may be signaled. As an example, the information may be defined and signaled as an SEI message. The information may be signaled at one or more of a sequence level, a picture level, a slice level, or a tile level.

Meanwhile, according to one embodiment of the present disclosure, information indicating whether the point cloud encoding/decoding method based on the hyperprior model of the present disclosure is used and/or one or more parameters used in the method of the present disclosure may be stored according to the bitstream structure.

As an example, information indicating whether the method of the present disclosure is used may be stored and transmitted by recording in at least one of a Sequence Parameter Set (SPS), a Geometry Parameter Set (GPS), a Geometry Data Unit (GDU), and a Trisoup Data Unit (TDU).

However, the bitstream structure disclosed above is merely an example, and may be recorded, stored, and transmitted in a bitstream structure used for encoding/decoding other point clouds.

As an example, one or more parameters used in the method of the present disclosure may be stored and transmitted by recording in at least one of a Sequence Parameter Set (SPS), a Geometry Parameter Set (GPS), a Geometry Data Unit (GDU), and a Trisoup Data Unit (TDU).

However, the bitstream structure disclosed above is merely an example, and may be recorded, stored, and transmitted in a bitstream structure used for encoding/decoding other point clouds.

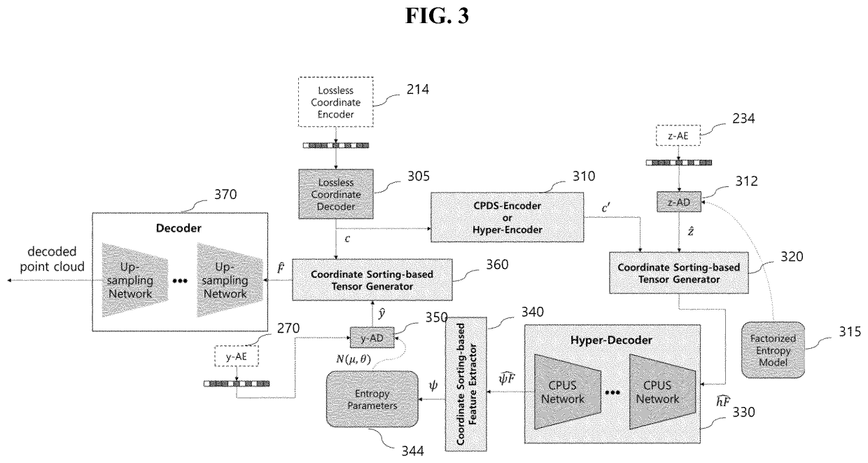

FIG. 3 is a diagram illustrating a point cloud decoding apparatus based on a hyperprior model according to one embodiment of the present disclosure.

The hyperprior entropy model-based point cloud decoder in this disclosure may reconstruct the coordinates (c′) of [symbol] using only the coordinate information (c) of \hat{F} by performing coordinate-preserving down-sampling and coordinate-preserving up-sampling. In other words, there is no need to receive additional information about c′ from the encoder. This will be discussed in detail below.

Referring to FIG. 3, the hyper encoder 310 may obtain first coordinate information by performing down-sampling on the decoded initial coordinate information.

According to one embodiment of the present disclosure, down-sampling may be performed by receiving only coordinate information (c) during the decoding process. Coordinate information encoded through a lossless encoder 214 may be decoded through a lossless decoder 305. As a result of performing down-sampling on the decoded coordinate information (c), down-sampled coordinate information (c′) may be obtained.

According to one embodiment of the present disclosure, when performing down-sampling on coordinate information, a connection relationship between down-sampled coordinate information and coordinate information before down-sampling may be stored. Coordinate information before down-sampling may be reconstructed as it is during up-sampling through the connection relationship.

According to one embodiment of the present disclosure, the connection relationship between the down-sampled coordinate information and the coordinate information before down-sampling may be generated in the form of a coordinate vector, an index map, or an adjacency list, etc., to trace the correspondence relationship of pixels or voxels.

Alternatively, the connection between the down-sampled coordinate information and the coordinate information before down-sampling may be generated by specifying a down-sampling method. For example, if a method of selecting and sampling only voxel existing at a specific position is specified, the connection relationship may be generated by considering the specific position. For example, the voxel existing at the specific position may be a voxel at the upper right of the point cloud.

However, the above-described method is merely an example, and a variety of different methods for creating connection relationships between coordinates may be used.

According to one embodiment of the present disclosure, information indicating whether down-sampling is performed may be signaled. As an example, the information may be defined and signaled as an SEI message. The information may be signaled at one or more of a sequence level, a picture level, a slice level, or a tile level.

Referring to FIG. 3, the arithmetic decoding unit 312 may perform arithmetic decoding on feature information.

The tensor output through down-sampling may be used as hyperprior data through up-sampling. In this case, arithmetic decoding may be performed on the feature information to be changed into hyperprior feature information. As an example, a factorized entropy model 315 may be used.

According to one embodiment of the present disclosure, information indicating that the extracted feature information is used as hyperprior data may be signaled. That is, information indicating whether the extracted feature information is to be derived as hyperprior feature information may be signaled. As an example, the information may be defined and signaled as an SEI message. The information may be signaled at one or more of a sequence level, a picture level, a slice level, or a tile level.

Referring to FIG. 3, the tensor generation unit 320 may generate a first tensor based on the first coordinate information and the first feature information.

According to one embodiment of the present disclosure, a tensor may be generated by receiving arithmetic decoded feature information as input.

A tensor ( [symbol] ) may be created by connecting feature information (\hat{z}) to coordinate information (c′) based on the sorting order of the coordinate information.

Information on a coordinate information sorting method used in generating a tensor may be signaled. As an example, the information may be defined and signaled as an SEI message. The information may be signaled at one or more of a sequence level, a picture level, a slice level, or a tile level.

As for the coordinate sorting method used, a detailed description thereof is omitted here, as it has been examined with reference to FIG. 2.

Referring to FIG. 3, the hyper decoder 330 may perform up-sampling on the generated first tensor.

According to one embodiment of the present disclosure, up-sampling may be performed by receiving a tensor generated by the tensor generation unit 320 as input. As a result of performing up-sampling, a tensor ( [symbol] ) may be obtained. By performing up-sampling using the connection relationship between the down-sampled coordinate information and the coordinate information before down-sampling may be reconstructed without loss.

According to one embodiment of the present disclosure, the connection relationship between the down-sampled coordinate information and the coordinate information before down-sampling may be generated in the form of a coordinate vector, an index map, or an adjacency list, etc., to track the correspondence relationship of pixels or voxels.

Alternatively, the connection between the down-sampled coordinate information and the coordinate information before down-sampling may be generated by specifying a down-sampling method. For example, if a method of selecting and sampling only voxel existing at a specific position is specified, the connection relationship may be generated by considering the specific position. For example, the voxel existing at the specific position may be a voxel at the upper right of the point cloud.

However, the above-described method is merely an example, and a variety of different methods for creating connection relationships between coordinates may be used.

According to one embodiment of the present disclosure, information indicating whether down-sampling is performed may be signaled. As an example, the information may be defined and signaled as an SEI message. The information may be signaled at one or more of a sequence level, a picture level, a slice level, or a tile level.

Referring to FIG. 3, the feature extraction unit 340 may extract second feature information based on the sorting order of second coordinate information included in the up-sampled first tensor.

According to one embodiment of the present disclosure, feature information (Ψ) may be extracted from a tensor ( [symbol] ) obtained as a result of performing up-sampling.

Information on a coordinate information sorting method used in extracting feature information may be signaled. As an example, the information may be defined and signaled as an SEI message. The information may be signaled at one or more of a sequence level, a picture level, a slice level, or a tile level.

As for the coordinate sorting method used, a detailed description thereof is omitted here, as it has been examined with reference to FIG. 2.

Referring to FIG. 3, the hyperprior feature information may be derived from the second feature information based on the hyper entropy model 344.

According to one embodiment of the present disclosure, learning based on a hyperprior model may be performed on extracted feature information. By learning feature information using a hyperprior entropy model 344, the feature information may be changed into hyperprior feature information having a mean (μ) and a scale (θ).

Referring to FIG. 3, the arithmetic decoding unit 350 may perform arithmetic decoding on the hyperprior feature information.

The arithmetic decoding unit 350 may perform arithmetic decoding on the hyperprior feature information obtained using the hyperprior entropy model.

Meanwhile, according to one embodiment of the present disclosure, information indicating whether to use (derive) hyperprior feature information may be signaled. As an example, the information may be defined and signaled as an SEI message. The information may be signaled at one or more of a sequence level, a picture level, a slice level, or a tile level.

Referring to FIG. 3, the tensor generation unit 360 may generate a second tensor (\hat{F}) based on the hyperprior feature information (ŷ) on which arithmetic decoding is performed.

Referring to FIG. 3, the decoder 370 may reconstruct the point cloud based on the second tensor.

To reconstruct the point cloud in the decoder 370, an up-sampling network-based decoding technique, which is commonly used in the field of autoencoder-based point cloud compression, may be used.

In addition to the above technique, a technique may be used to increase the resolution of input data to high resolution and generate a point cloud using a network including one or more MLPs (e.g., Generative Adversarial Networks (GAN)).

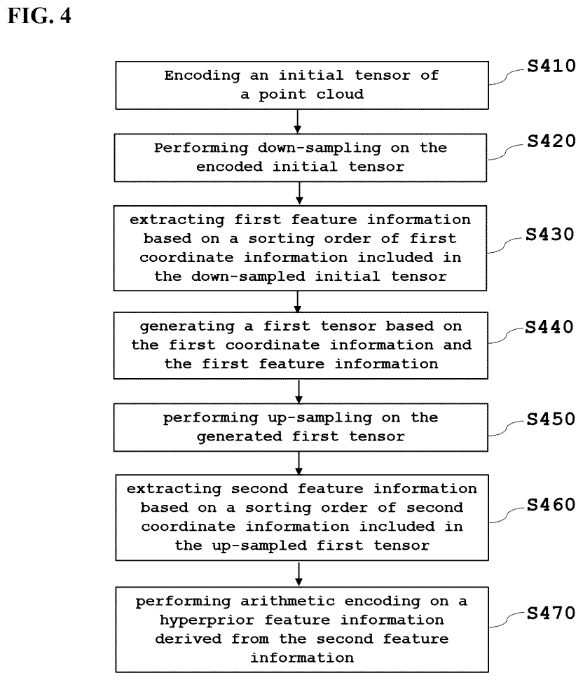

FIG. 4 is a flowchart of a point cloud encoding method based on a hyperprior model according to one embodiment of the present disclosure.

Referring to FIG. 4, down-sampling of a point cloud may be performed and an initial tensor including coordinate information and feature information may be encoded S410.

The operation may be performed in the encoder 210, and as described with reference to FIG. 2, a detailed description thereof will be omitted here.

Referring to FIG. 4, down-sampling may be performed on the encoded initial tensor S420.

The operation may be performed in the hyper encoder 220, and as described with reference to FIG. 2, a detailed description thereof will be omitted here.

Referring to FIG. 4, first feature information may be extracted based on a sorting order of first coordinate information included in the down-sampled initial tensor S430.

The operation may be performed in the feature extraction unit 230, and as described with reference to FIG. 2, a detailed description thereof will be omitted here.

Arithmetic coding may be performed on the extracted feature information in the arithmetic encoding unit 234 and the arithmetic decoding unit 236. Before performing the arithmetic encoding, quantization may be performed in the quantization unit 232. In this regard, as described with reference to FIG. 2, a detailed description thereof will be omitted here.

The tensor output through down-sampling may be used as hyperprior data through up-sampling. In this case, the feature information to be changed into hyperprior feature information may be compressed through arithmetic coding. As an example, a factorized entropy model may be used.

According to one embodiment of the present disclosure, information indicating that the extracted feature information is used as hyperprior data may be signaled. That is, information indicating whether the extracted feature information is to be derived as hyperprior feature information may be signaled. As an example, the information may be defined and signaled as an SEI message. The information may be signaled at one or more of a sequence level, a picture level, a slice level, or a tile level.

Referring to FIG. 4, a first tensor may be generated based on the first coordinate information and the first feature information S440.

The operation may be performed in the tensor generation unit 240, and as described with reference to FIG. 2, a detailed description thereof will be omitted here.

Referring to FIG. 4, up-sampling may be performed on the generated first tensor S450.

The operation may be performed in the hyper decoder 250, and as described with reference to FIG. 2, a detailed description thereof will be omitted here.

Referring to FIG. 4, second feature information may be extracted based on a sorting order of second coordinate information included in the up-sampled first tensor S460.

The operation may be performed in the feature extraction unit 260, and as described with reference to FIG. 2, a detailed description thereof will be omitted here.

Referring to FIG. 4, arithmetic encoding may be performed on hyperprior feature information derived from the second feature information S470.

The hyperprior feature information may be derived using the hyperprior entropy model, and as described with reference to FIG. 2, a detailed description thereof will be omitted here.

Arithmetic encoding for the hyperprior feature information may be performed in the arithmetic encoding unit 270, and as described with reference to FIG. 2, a detailed description thereof will be omitted here.

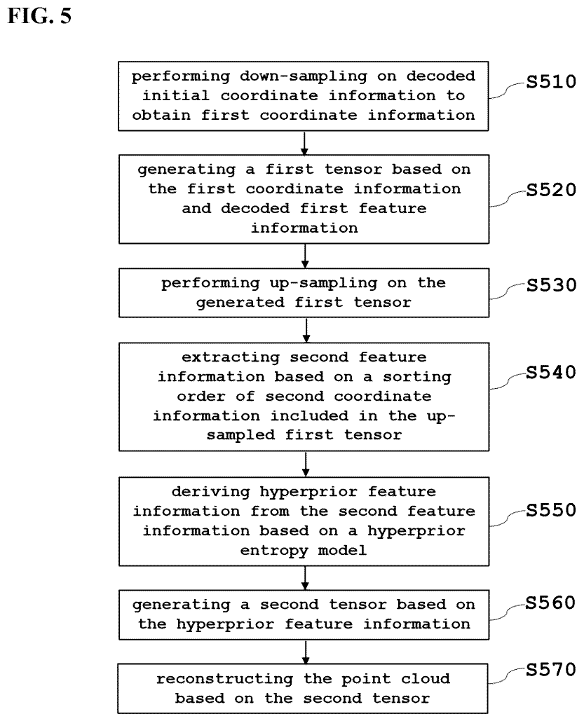

FIG. 5 is a flowchart of a point cloud decoding method based on a hyperprior model according to one embodiment of the present disclosure.

Referring to FIG. 5, down-sampling may be performed on decoded initial coordinate information to obtain first coordinate information S510.

According to one embodiment of the present disclosure, down-sampling during the decoding process may be performed by inputting only coordinate information.

According to one embodiment of the present disclosure, down-sampling in the decoding process may be performed by inputting only coordinate information (c). Coordinate information encoded through a lossless encoder 214 may be decoded through a lossless decoder 305.

As a result of performing down-sampling on the decoded coordinate information (c), down-sampled coordinate information (c′) may be obtained.

The operation may be performed in the hyper decoder 310, and as described with reference to FIG. 3, a detailed description thereof will be omitted here.

Referring to FIG. 5, a first tensor may be generated based on the first coordinate information and decoded first feature information S520.

The operation may be performed in the tensor generation unit 320, and as described with reference to FIG. 3, a detailed description thereof will be omitted here.

Referring to FIG. 5, up-sampling may be performed on the generated first tensor S530.

The operation may be performed in the hyper decoder 330, and as described with reference to FIG. 3, a detailed description thereof will be omitted here.

Referring to FIG. 5, second feature information may be extracted based on a sorting order of second coordinate information included in the up-sampled first tensor S540.

The operation may be performed in the feature extraction unit 340, and as described with reference to FIG. 3, a detailed description thereof will be omitted here.

Referring to FIG. 5, hyperprior feature information may be derived from the second feature information based on a hyperprior entropy model S550.

The hyperprior feature information may be derived using the hyperprior entropy model 344, and as described with reference to FIG. 3, a detailed description thereof will be omitted here.

Arithmetic decoding of the hyperprior feature information may be performed in the arithmetic decoding unit 350, and as described with reference to FIG. 3, a detailed description thereof will be omitted here.

Referring to FIG. 5, a second tensor may be generated based on the hyperprior feature information S560.

The operation may be performed in the tensor generation unit 360, and as described with reference to FIG. 3, a detailed description thereof will be omitted here.

Referring to FIG. 5, the point cloud may be reconstructed based on the second tensor S570.

The operation may be performed in the decoder 370, and as described with reference to FIG. 3, a detailed description thereof will be omitted here.

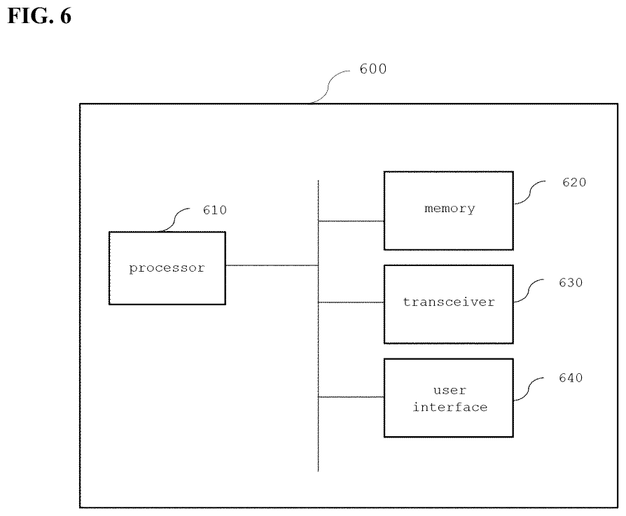

FIG. 6 is a block diagram illustrating an apparatus according to one embodiment of the present disclosure.

The apparatus 600 may include one or more processors 610, one or more memories 620, one or more transceivers 630, one or more user interfaces 640, etc. The memory 620 may be included in the processor 610 or may be configured separately. The memory 620 may store instructions that cause the apparatus 600 to perform operations when executed by the processor 610. The transceiver 630 may transmit and/or receive signals, data, etc. that the apparatus 600 exchanges with other entities. The user interface 640 may receive an input of the user for the apparatus 600 or provide an output of the apparatus 600 to the user. Among the components of the apparatus 600, components other than the processor 610 and the memory 620 may not be included in some cases, and other components not shown in FIG. 6 may be included in the apparatus 600.

The processor 610 may be configured to cause the apparatus 600 to perform operations of the device according to various examples of the present disclosure. Although not illustrated in FIG. 6, the processor 610 may be configured as a set of modules each performing a function. The modules may be configured in the form of hardware and/or software.

The apparatus 600 may perform encoding of a point cloud and/or decoding of a point cloud.

The processor 610 of the encoding apparatus 600 may be configured to encode an initial tensor of the point cloud, perform down-sampling on the encoded initial tensor, extract first feature information based on a sorting order of first coordinate information included in the down-sampled initial tensor, generate a first tensor based on the first coordinate information and the first feature information, perform up-sampling on the generated first tensor, extract second feature information based on a sorting order of second coordinate information included in the up-sampled first tensor, and perform arithmetic encoding on a hyperprior feature information derived from the second feature information.

The processor 610 of the decoding apparatus 600 may be configured to perform down-sampling on decoded initial coordinate information to obtain first coordinate information, generate a first tensor based on the first coordinate information and decoded first feature information, perform up-sampling on the generated first tensor, extract second feature information based on a sorting order of second coordinate information included in the up-sampled first tensor, derive hyperprior feature information from the second feature information based on a hyperprior entropy model, generate a second tensor based on the hyperprior feature information, and reconstruct the point cloud based on the second tensor.

Here, the processor 610 of the decoding apparatus 600 may generate/obtain initial coordinate information and first feature information through the transceiver 630.

A component described in illustrative embodiments of the present disclosure may be implemented by a hardware element. For example, the hardware element may include at least one of a digital signal processor (DSP), a processor, a controller, an application-specific integrated circuit (ASIC), a programmable logic element such as an FPGA, a GPU, other electronic device, or a combination thereof.

At least some of functions or processes described in illustrative embodiments of the present disclosure may be implemented by software and the software may be recorded in a recording medium. A component, a function, and a process described in illustrative embodiments may be implemented by a combination of hardware and software.

A method according to an embodiment of the present disclosure may be implemented by a program which may be performed by a computer and the computer program may be recorded in a variety of recording media such as a magnetic storage medium, an optical reading medium, a digital storage medium, etc.

A variety of technologies described in the present disclosure may be implemented by a digital electronic circuit, computer hardware, firmware, software, or a combination thereof. The technologies may be implemented by a computer program product, that is, a computer program tangibly implemented on an information medium or a computer program processed by a computer program (for example, a machine-readable storage device (for example, a computer-readable medium) or a data processing device) or a data processing device or implemented by a signal propagated to operate a data processing device (for example, a programmable processor, a computer, or a plurality of computers).

Computer program(s) may be written in any form of a programming language including a compiled language or an interpreted language and may be distributed in any form including a stand-alone program or module, a component, a subroutine, or other unit suitable for use in a computing environment. A computer program may be performed by one computer or a plurality of computers which are located at one site or spread across multiple sites and are interconnected by a communication network.

An example of a processor suitable for executing a computer program includes a general-purpose and special-purpose microprocessor and one or more processors of a digital computer. In general, a processor receives an instruction and data in a read-only memory (ROM), a random-access memory (RAM), or both memories. A component of a computer may include at least one processor for executing an instruction and at least one memory device for storing an instruction and data. In addition, a computer may include one or more mass storage devices for storing data, for example, a magnetic disk, a magneto-optical disc, or an optical disc, or may be connected to the mass storage device to receive and/or transmit data. An example of an information medium suitable for implementing a computer program instruction and data includes a semiconductor memory device (for example, a magnetic medium such as a hard disk, a floppy disk, or a magnetic tape), an optical medium such as a compact disc read-only memory (CD-ROM), a digital video disc (DVD), etc., a magneto-optical medium such as a floptical disk, and a ROM, a RAM, a flash memory, an EPROM (Erasable Programmable ROM), an EEPROM (Electrically Erasable Programmable ROM) and other known computer readable medium. A processor and a memory may be complemented or integrated by a special-purpose logic circuit.

A processor may execute an operating system (OS) and one or more software applications executed in an OS. A processor device may also respond to software execution to access, store, manipulate, process and generate data. For simplicity, a processor device is described in the singular, but those skilled in the art may understand that a processor device may include a plurality of processing elements and/or various types of processing elements. For example, the processor device may include a plurality of processors or a processor and a controller. In addition, the processor device may configure a different processing structure like parallel processors. In addition, a computer readable medium means all media which may be accessed by a computer and may include both a computer storage medium and a transmission medium.

The present disclosure includes detailed description of various detailed implementation examples. However, it should be understood that the detailed content does not limit a scope of claims or an invention proposed in the present disclosure and describes features of a specific illustrative embodiment.

Features which are individually described in illustrative embodiments of the present disclosure may be implemented by a single illustrative embodiment. Conversely, a variety of features described regarding a single illustrative embodiment in the present disclosure may be implemented by a combination or a proper sub-combination of a plurality of illustrative embodiments. Further, in the present disclosure, the features may be operated by a specific combination and may be described as the combination is initially claimed, but in some cases, one or more features may be excluded from a claimed combination or a claimed combination may be changed in a form of a sub-combination or a modified sub-combination.

Likewise, although an operation is described in specific order in a drawing, it should not be understood that it is necessary to execute operations in specific turn or order or it is necessary to perform all operations in order to achieve a desired result. In a specific case, multitasking and parallel processing may be useful. In addition, it should not be understood that a variety of device components should be separated in illustrative embodiments of all embodiments and the above-described program component and device may be packaged into a single software product or multiple software products.

Illustrative embodiments disclosed herein are just illustrative and do not limit a scope of the present disclosure. Those skilled in the art may recognize that illustrative embodiments may be variously modified without departing from claims and a spirit and a scope of equivalents thereto.

Accordingly, the present disclosure includes all other replacements, modifications and changes belonging to the following claim.

What is claimed is:

1. A method for decoding a point cloud, comprising:
performing down-sampling on decoded initial coordinate information to obtain first coordinate information;
generating a first tensor based on the first coordinate information and decoded first feature information;
performing up-sampling on the generated first tensor;
extracting second feature information based on a sorting order of second coordinate information included in the up-sampled first tensor;
deriving hyperprior feature information from the second feature information based on a hyperprior entropy model;
generating a second tensor based on the hyperprior feature information; and
reconstructing the point cloud based on the second tensor.

2. The method of claim 1, wherein based on performing the down-sampling, connection relationship information between the decoded initial coordinate information and the first coordinate information is generated.

3. The method of claim 2, wherein the connection relationship information is determined by a method of representing a connection relationship of a predetermined pixel or voxel, and
wherein the method includes at least one of a coordinate vector, an index map, and an adjacency list method for tracking a correspondence relationship.

4. The method of claim 2, wherein the connection relationship information is generated based on a specified down-sampling method.

5. The method of claim 2, wherein the up-sampling for the first tensor is performed based on the connection relationship information.

6. The method of claim 1, wherein the first tensor is generated by connecting the first coordinate information and the decoded first feature information, and
wherein the connecting is performed based on a sorting order of the first coordinate information.

7. The method of claim 1, wherein the second tensor is generated by connecting the decoded initial coordinate information and the hyperprior feature information, and
wherein the connecting is performed based on a sorting order of the decoded initial coordinate information.

8. The method of claim 1, wherein the sorting order of the second coordinate information is determined by a predetermined coordinate information sorting method,
wherein the method includes at least one of a space filling algorithm and an orthogonal coordinate system-based sorting method, and
wherein the space filling algorithm includes at least one of a Morton code and a Hilbert curve.

9. The method of claim 1, wherein information indicating whether down-sampling is performed on the decoded initial coordinate information is signaled.

10. The method of claim 1, wherein information indicating whether to derive the hyperprior feature is signaled.

11. An apparatus for decoding a point cloud, comprising:
one or more transceivers;
one or more memories;
and one or more processors,
wherein the one or more processors being configured to:
perform down-sampling on decoded initial coordinate information to obtain first coordinate information,
generate a first tensor based on the first coordinate information and decoded first feature information,
perform up-sampling on the generated first tensor,
extract second feature information based on a sorting order of second coordinate information included in the up-sampled first tensor,
derive hyperprior feature information from the second feature information based on a hyperprior entropy model,
generate a second tensor based on the hyperprior feature information, and
reconstruct the point cloud based on the second tensor.

12. A method for encoding a point cloud, comprising:
encoding an initial tensor of the point cloud;
performing down-sampling on the encoded initial tensor;
extracting first feature information based on a sorting order of first coordinate information included in the down-sampled initial tensor;
generating a first tensor based on the first coordinate information and the first feature information;
performing up-sampling on the generated first tensor; extracting second feature information based on a sorting order of second coordinate information included in the up-sampled first tensor; and
performing arithmetic encoding on a hyperprior feature information derived from the second feature information.

13. The method of claim 12, wherein based on performing the down-sampling, connection relationship information between initial coordinate information included in the initial tensor and the first coordinate information is generated.

14. The method of claim 13, wherein the connection relationship information is determined by a method of representing a connection relationship of a predetermined pixel or voxel, and
wherein the method includes at least one of a coordinate vector, an index map, and an adjacency list method for tracking a correspondence relationship.

15. The method of claim 13, wherein the connection relationship information is generated based on a specified down-sampling method.

16. The method of claim 13, wherein the up-sampling for the first tensor is performed based on the connection relationship information.

17. The method of claim 12, wherein the first tensor is generated by connecting the first coordinate information and the first feature information, and
wherein the connecting is performed based on the sorting order of the first coordinate information.

18. The method of claim 12, wherein the sorting order of the second coordinate information is determined by a predetermined coordinate information sorting method,
wherein the method includes at least one of a space filling algorithm and an orthogonal coordinate system-based sorting method, and
wherein the space filling algorithm includes at least one of a Morton code and a Hilbert curve.

19. The method of claim 12, wherein information indicating whether to derive the hyperprior feature is signaled.

20. An apparatus for encoding a point cloud, comprising:
one or more transceivers;
one or more memories;
and one or more processors,
wherein the one or more processors being configured to:
encode an initial tensor of the point cloud,
perform down-sampling on the encoded initial tensor,
extract first feature information based on a sorting order of first coordinate information included in the down-sampled initial tensor,
generate a first tensor based on the first coordinate information and the first feature information,
perform up-sampling on the generated first tensor,
extract second feature information based on a sorting order of second coordinate information included in the up-sampled first tensor, and
perform arithmetic encoding on a hyperprior feature information derived from the second feature information.
